(19) United States
(12) Patent Application Publication
(10) Pub. No.: US 2008/0158861 A1
(43) Pub. Date: Jul. 3, 2008

(54) Illuminated socket device

(75) Inventor: Kuo Chin Chiang, Taichung Hsien (TW)

Correspondence Address: CHARLES E. BAXLEY, ESQ., 90 JOHN STREET, THIRD FLOOR, NEW YORK, NY, 10038, US

(73) Assignee: Jeng Sheng Co., Ltd.

(21) Appl. No.: 11/647,054

(22) Filed: Dec. 27, 2006

(51) Int. Cl. B25B 23/18

(52) U.S. Cl. 362/120

(57) ABSTRACT

A socket device includes a housing having a passage formed in a driving shank, a coupler having a coupling member engaged into the housing for receiving one or more batteries, a circuit board disposed in the housing and having a conductor member electrically coupled to the coupler and the case electrode of the battery and coupled to a light member, and an operating device disposed in the housing for selectively coupling the central electrode of the battery to the other conductor member in order to selectively energize the light member, and for allowing the light member to be operated by the users.

### BACKGROUND OF THE INVENTION

1. Field of the Invention

The present invention relates to an illuminated socket device or tool, and more particularly to a socket device including an illuminating or light device for lighting the environment and for allowing the socket device or the tool to be easily operated by the users.

2. Description of the Prior Art

For allowing the environment to be lighted or to be clearly seen by the users, various kinds of typical light devices or illuminating structures have been developed and provided in various kinds of typical tool devices to allow the typical tool devices to be easily operated by the users.

For example, U.S. Pat. No. 4,324,158 to Le Roy discloses one of the typical illuminated wrenches including a light source selectively engaged into a driving stud of a drive member, or detachably attached to a head of a handle.

However, the light source may be engaged into the driving stud of the particularly designed or manufactured drive member and may not be attached onto different drive tools.

U.S. Pat. No. 5,477,434 to Reed discloses another typical extension bar with a built-in light for attaching or engaging with a portable driving tool, in which the extension bar includes a push button provided in an internal chamber of a socket for being depressed or actuated by a coupling member of a ratchet mechanism.

However, the light device may not be switched on and off or may not be controlled by the users when or after the coupling member of the ratchet mechanism has been engaged into the internal chamber of the socket.

U.S. Pat. No. 6,079,846 to Huang discloses a typical socket having a light device for attaching or engaging with various driving tools, in which the socket also includes a push button or switch provided in an orifice of a cap for being depressed or actuated by a driving stem of a driving tool.

However, similarly, the light device also may not be switched on and off or may not be controlled by the users when or after the driving stem of the driving tool has been engaged into the orifice of the cap.

U.S. Pat. No. 6,283,607 to Lin discloses another typical socket wrench comprising a light device for attaching or engaging into a handle body which will then be attached onto a handle of the socket wrench, and a press button for operating or actuating the light device.

However, the light device may only be engaged into the handle of the particularly designed or manufactured socket wrench and may not be attached onto different drive tools.

The present invention has arisen to mitigate and/or obviate the afore-described disadvantages of the conventional socket devices or tool members.

### SUMMARY OF THE INVENTION

The primary objective of the present invention is to provide a socket device including an illuminating or light device for lighting the environment and for allowing the socket device or the tool to be easily operated by the users.

In accordance with one aspect of the invention, there is provided a socket device comprising a housing including a chamber formed therein and including a driving shank extended therefrom, and including a passage formed in the driving shank and communicating with the chamber of the housing, a coupler including a coupling member extended therefrom for engaging into the chamber of the housing and for allowing the housing to be rotated by the coupler, at least one battery engaged in the coupler and including a case electrode electrically coupled the coupler, and including a central electrode, a circuit board disposed in the chamber of the housing and including a first conductor member electrically coupled to the coupler and then electrically coupled to the case electrode of the battery, a second conductor member, a light member electrically coupled to the first conductor member and the second conductor member and engaged in the passage of the driving shank, and an operating device disposed in the housing for selectively coupling the central electrode of the battery to the second conductor member in order to selectively energize the light member and for allowing the light member to be easily operated by the users.

The housing includes a conduit formed therein and communicating with the chamber of the housing, the operating device includes a shaft rotatably engaged in the conduit of the housing, and a conductive element is engaged onto the shaft and engaged with the second conductor member for selectively engaging with the central electrode of the battery.

The shaft includes a depression formed in an outer peripheral portion thereof, the conductive element is a conductor barrel engaged in the depression of the shaft. The shaft includes at least one peripheral shoulder formed therein for engaging with the conductor barrel and for anchoring and retaining the conductor barrel to the shaft.

The conductive element includes a slot formed therein, the shaft includes a protrusion extended therefrom and engaged through the slot of the conductive element. The shaft includes a knob for rotating the shaft relative to the housing.

The housing includes a receptacle engaged therein for receiving the circuit board therein. The housing includes a spring member engaged with the receptacle for biasing the first conductor member to engage with the coupler and for biasing the second conductor member to selectively engage with the conductive element.

The housing includes a casing engaged onto the light member and engaged in the passage of the driving shank. The housing includes a spring-biased projection engaged therein for engaging with the coupling member of the coupler and for retaining the coupling member of the coupler to the housing. The coupler includes a compartment formed in the coupling member for receiving the battery.

The coupler includes a container engaged into the compartment of the coupler for receiving the battery. The coupler includes a spring member engaged with the battery for biasing the central electrode of the battery to selectively engage with the conductive element.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a socket device for a driving tool in accordance with the present invention;

FIG. 2 is a partial cross sectional view of the socket device taken along lines 2-2 of FIG. 1;

FIG. 3 is a partial cross sectional view similar to FIG. 2, illustrating the operation of the socket device;

FIG. 4 is a perspective view of the socket device in which a portion of the socket device has been cut off for showing the inner structure of the socket device;

FIG. 5 is a cross sectional view of the socket device taken along lines 5-5 of FIG. 4;

FIG. 6 is an exploded view of the socket device; and

FIG. 7 is an enlarged partial perspective view illustrating an actuating or switch device of the socket device.

### DETAILED DESCRIPTION OF THE PREFERRED EMBODIMENT

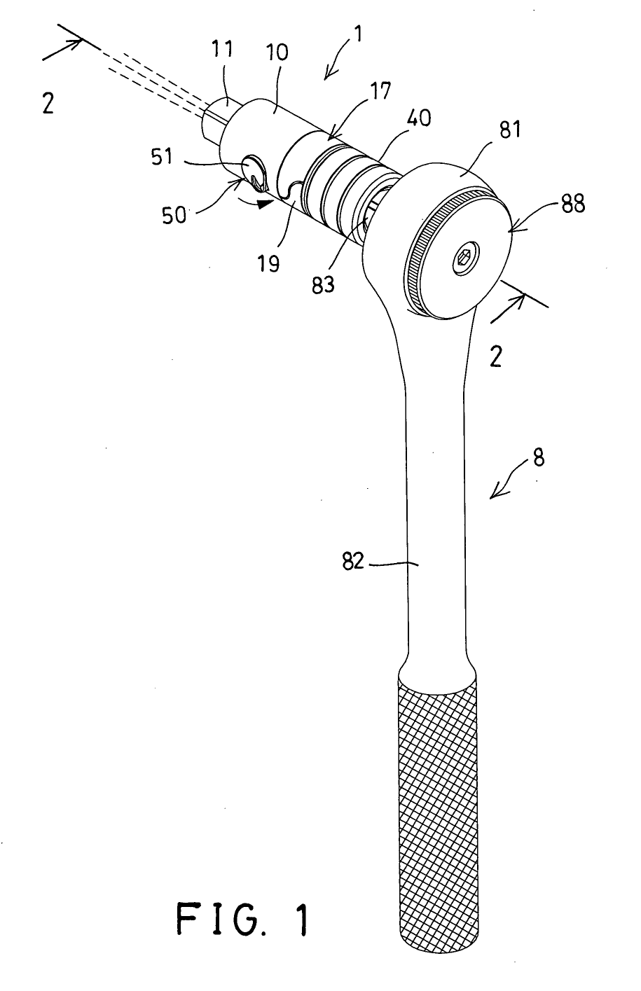

Referring to the drawings, and initially to FIGS. 1-6, a socket device 1 in accordance with the present invention is designed and provided for attaching to various kinds of driving tools 8, such as the socket wrench 8 as shown in FIGS. 1-3, in which the socket wrench 8 includes a driving gear or cartridge 80 rotatably disposed or engaged in an enlarged head 81 of a handle 82 and having a driving stem 83 extended therefrom for engaging with the socket device 1 or other tool members or fasteners, and a ratchet mechanism 88 disposed in the enlarged head 81 of the handle 82 and engaged with or between the cartridge 80 and the enlarged head 81 of the handle 82 for controlling the driving direction of the driving stem 83 by the handle 82. The ratchet mechanism 88 is typical and not related to the present invention, and thus will not be described in further details.

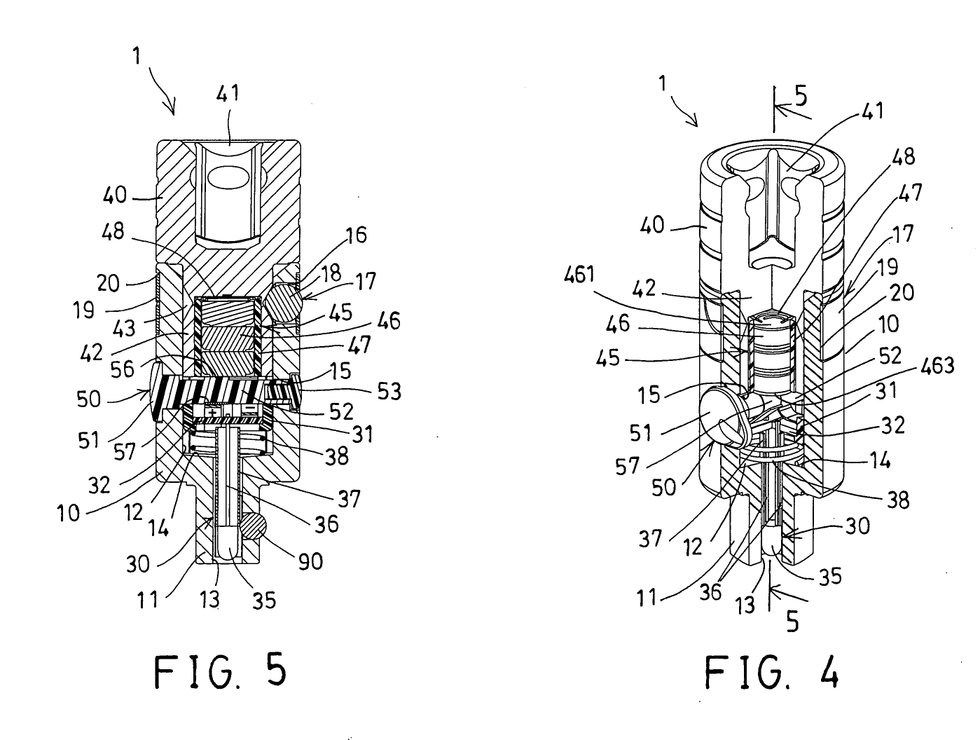

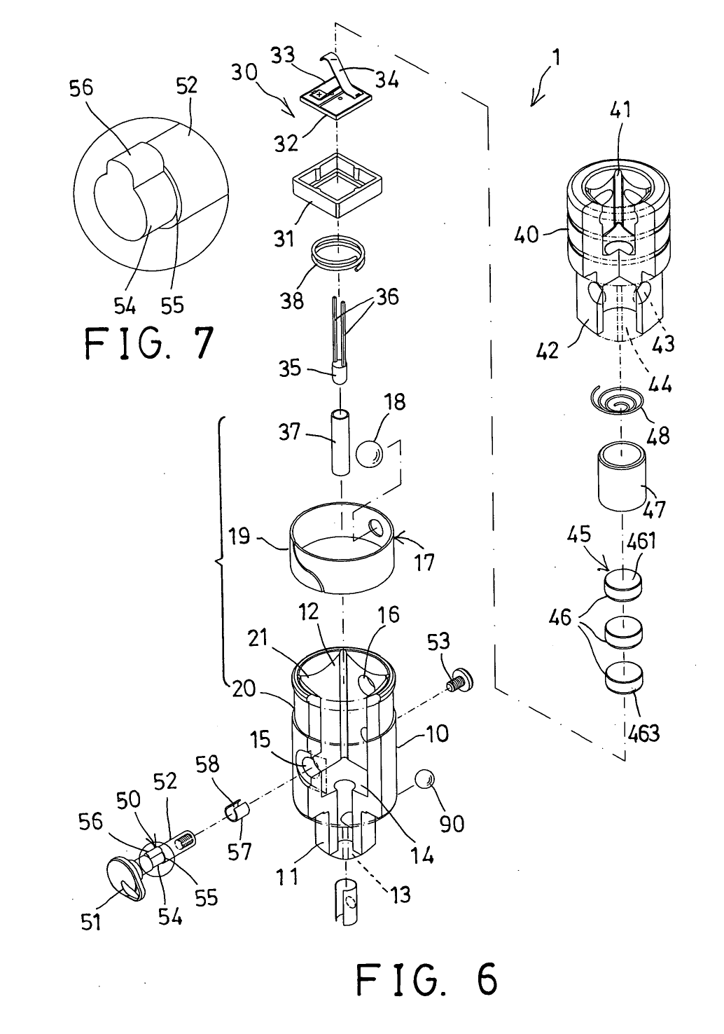

The socket device 1 comprises a cylindrical housing 10 including a driving shank 11 extended outwardly therefrom and having a non-circular cross section, such as a rectangular or square cross section for engaging with the fasteners, the tool extensions, or other tool members (not shown) to be rotated or driven by the socket device 1 and the socket wrench 8. The cylindrical housing 10 includes a chamber 12 formed therein and facing or opened upwardly, and a passage 13 formed therein, such as formed in the driving shank 11 and opened out through the driving shank 11 and communicating with the chamber 12 of the cylindrical housing 10 and having an inner diameter smaller than that of the chamber 12 of the cylindrical housing 10 for forming an inner peripheral shoulder 14 in the cylindrical housing 10. A detent 90 may be provided and engaged in the driving shank 11 (FIGS. 5, 6) for selectively engaging with the fasteners, the tool extensions, or other tool members (not shown) to be rotated.

The cylindrical housing 10 further includes a conduit 15 laterally formed therein (FIGS. 4-6), such as formed in the middle portion thereof, and intersecting or communicating with the chamber 12 of the cylindrical housing 10, and further includes an orifice 16 formed therein (FIGS. 5-6), such as formed in the upper portion thereof and also communicating with the chamber 12 of the cylindrical housing 10 for slidably receiving a spring-biased projection 17 which includes a ball 18 engaged in the orifice 16 of the cylindrical housing 10 and a spring collar or member 19 engaged onto the outer peripheral portion of the cylindrical housing 10 and engaged with the ball 18 for biasing the ball 18 to partially engage into the chamber 12 of the cylindrical housing 10. It is preferable that the cylindrical housing 10 further includes a peripheral recess 20 formed in the outer peripheral portion thereof for stably receiving and retaining the spring member 19 on the outer peripheral portion of the cylindrical housing 10.

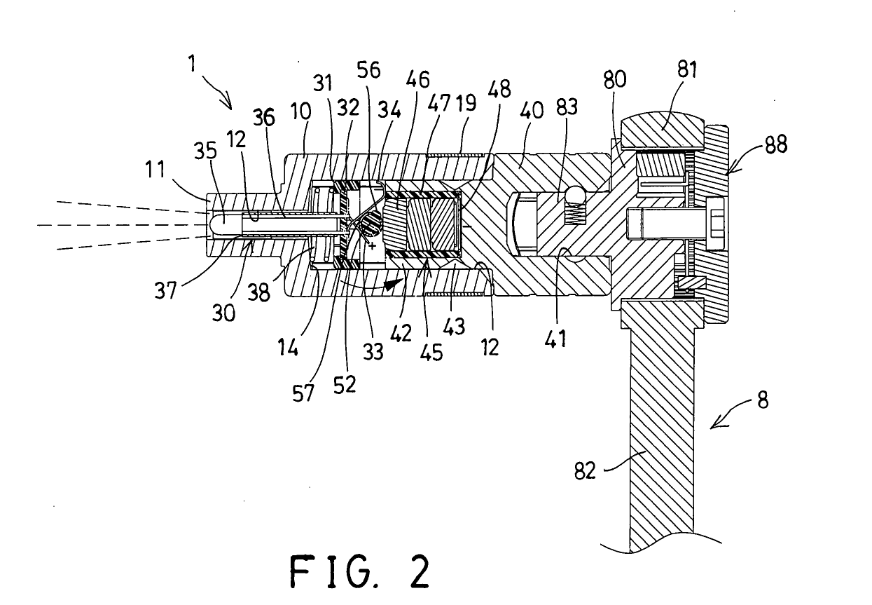

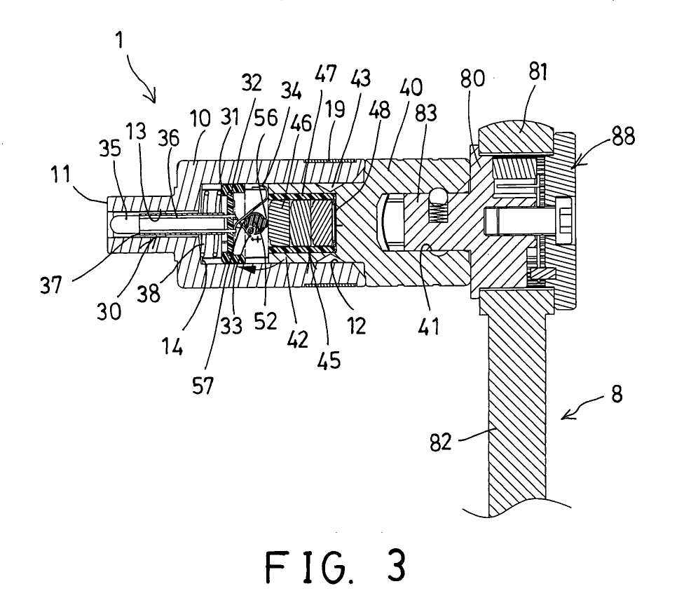

An illuminating device 30 is provided and engaged in the cylindrical housing 10 and includes a receptacle 31 engaged in the lower portion of the chamber 12 of the cylindrical housing 10 for receiving a circuit board 32 therein, in which the circuit board 32 includes two conductor blades or members 33, 34 attached thereto and spaced away from each other. A light member 35, such as a light crystal display, a light emitting diode or other illuminating member is engaged in the passage 13 of the driving shank 11 of the cylindrical housing 10 and includes two prongs 36 engaged through the circuit board 32 and electrically coupled to the conductor blades or members 33, 34 respectively (FIGS. 2, 3). It is further preferable that the illuminating device 30 further includes a protective casing 37 engaged onto the light member 35 for protecting the light member 35.

The light generated by the light member 35 may emit out through the protective casing 37 and the passage 13 of the driving shank 11 of the cylindrical housing 10 for lighting or illuminating the environment and for allowing the socket device 1 to be easily operated by the users. A spring member 38 may further be provided and attached or disposed between the cylindrical housing 10 and the receptacle 31 for biasing the receptacle 31 and the circuit board 32 away from the driving shank 11 or toward an outer opening 21 (FIG. 6) of the cylindrical housing 10.

The socket device 1 further includes a tool extension or coupler 40 having a non-circular engaging hole 41 formed therein for receiving or engaging with the driving stem 83 of the socket wrench 8 (FIGS. 2, 3) and for allowing the coupler 40 to be rotated or driven by the socket wrench 8. The coupler 40 includes a non-circular coupling member 42 extended outwardly therefrom for engaging into the non-circular chamber 12 of the cylindrical housing 10 and for allowing the cylindrical housing 10 to be rotated or driven by the coupler 40 or to be rotated in concert with the coupler 40, and includes one or more cavities 43 formed therein (FIGS. 2-3, 5-6), such as formed in the outer peripheral portion of the coupling member 42 for selectively engaging with the ball 18 of the spring-biased projection 17 (FIG. 5) and thus for allowing the coupling member 42 of the coupler 40 to be stably and detachably coupled or anchored or retained or positioned to the cylindrical housing 10.

The coupler 40 includes a space or compartment 44 formed therein, such as formed in the coupling member 42 for receiving an electric power source 45 which includes one or more batteries 46 engaged in a container 47 which is to be engaged into the compartment 44 of the coupler 40 (FIGS. 2-5), and another spring member 48 also engaged in the compartment 44 of the coupler 40 and electrically coupling a case electrode 461 of the batteries 46 to the coupler 40 and for biasing the batteries 46 outward of the container 47 and the compartment 44 of the coupler 40. The coupling member 42 of the coupler 40 is electrically coupled to one of the conductor members 34 (FIGS. 2, 3) for electrically coupling to the light member 35 for allowing the batteries 46 to selectively supply the electric power energy to the light member 35. An actuating or switching or operating means or device 50 may further be provided and disposed in the cylindrical housing 10 for selectively coupling the central electrode 463 of the batteries 46 to the other conductor member 33.

For example, the operating means or device 50 includes a knob 51 formed or provided on one end of a non-conductive shaft 52 which is rotatably disposed or engaged into the conduit 15 of the cylindrical housing 10 and for rotating the shaft 52 relative to the cylindrical housing 10, and a fastener 53 is attached or secured to the other end of the shaft 52 and opposite to or distal to the knob 51 for rotatably securing or retaining the shaft 52 to the cylindrical housing 10 and for preventing the shaft 52 from being disengaged from the cylindrical housing 10. The shaft 52 includes a diameter reduced portion or an outer peripheral depression 54 formed therein (FIGS. 6, 7), such as formed in the middle portion thereof for forming or defining two inner peripheral shoulders 55 in the shaft 52, and includes a swelling or protrusion 56 extended outwardly therefrom, such as extended radially out from the middle portion thereof and into the outer peripheral depression 54 thereof and located between the inner peripheral shoulders 55 of the shaft 52 and extended radially out of the shaft 52, best shown in FIGS. 6 and 7.

A conductive barrel or element 57 is engaged onto the shaft 52 and preferably engaged and retained in the outer peripheral depression 54 of the shaft 52 and stably engaged with the inner peripheral shoulders 55 of the shaft 52 for allowing the conductive barrel or element 57 to be stably attached or anchored onto the shaft 52 and for protecting the conductive barrel or element 57 from moving or rotating relative to the shaft 52. The conductive barrel or element 57 is electrically coupled to the conductor blade or member 33 (FIGS. 2, 3), but offset from the other conductor member 34 (FIGS. 4, 5), and for selectively engaging with the central electrode 463 of the batteries 46 (FIG. 2) and thus for allowing the light member 35 to be selectively energized by the batteries 46. The conductive barrel or element 57 includes a groove or slot 58 formed therein for receiving the protrusion 56 of the shaft 52, and the protrusion 56 of the shaft 52 may be selectively engaged with the central electrode 463 of the batteries 46 (FIGS. 3, 5) and thus for selectively switching off the light member 35.

The spring member 48 may bias or force the central electrode 463 of the batteries 46 to selectively engage with the conductive barrel or element 57 (FIG. 2) or the protrusion 56 of the shaft 52 (FIGS. 3, 5). The other spring member 38 may bias or force the conductor blade or member 33 to engage with the conductive barrel or element 57 or the shaft 52, and may also bias or force the other conductor blade or member 34 to engage with the coupling member 42 of the coupler 40 (FIGS. 2, 3). In operation, the shaft 52 may be rotated relative to the cylindrical housing 10 with such as the knob 51 in order to selectively engage the conductive barrel or element 57 with the central electrode 463 of the batteries 46 (FIG. 2) and so as to selectively energize or actuate the light member 35. The shaft 52 may also be rotated relative to the cylindrical housing 10 to selectively disengage the conductive barrel or element 57 from the central electrode 463 of the batteries 46 and to selectively engage the protrusion 56 of the shaft 52 with the central electrode 463 of the batteries 46 (FIGS. 3, 5) in order to selectively switch or turn off the light member 35.

It is to be noted that the illuminating device 30 provided and engaged in the cylindrical housing of the typical socket devices may not be switched on and off or may not be controlled by the users when or after the coupling member of the ratchet mechanism has been engaged into the internal chamber of the socket device, and the typical socket devices normally include a tiny structure that have no spaces provided for receiving the switching or operating device. However, in the present invention, a shaft 52 of an actuating or switching or operating means or device 50 is provided for selectively coupling the central electrode 463 of the batteries 46 to the other conductor member 33 in order to selectively switch on and off the light member 35. The actuating or switching or operating means or device 50 will not occupy much space of the cylindrical housing 10.

Accordingly, the socket device in accordance with the present invention includes an illuminating or light device for lighting the environment and for allowing the socket device or the tool to be easily operated by the users.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A socket device comprising:
a housing including a chamber formed therein and including a driving shank extended therefrom, and including a passage formed in said driving shank and communicating with said chamber of said housing,
a coupler including a coupling member extended therefrom for engaging into said chamber of said housing and for allowing said housing to be rotated by said coupler,
at least one battery engaged in said coupler and including a case electrode electrically coupled said coupler, and including a central electrode,
a circuit board disposed in said chamber of said housing and including a first conductor member electrically coupled to said coupler and then electrically coupled to said case electrode of said at least one battery, a second conductor member,
a light member electrically coupled to said first conductor member and said second conductor member and engaged in said passage of said driving shank, and
an operating device disposed in said housing for selectively coupling said central electrode of said at least one battery to said second conductor member in order to selectively energize said light member.

2. The socket device as claimed in claim 1, wherein said housing includes a conduit formed therein and communicating with said chamber of said housing, said operating device includes a shaft rotatably engaged in said conduit of said housing, and a conductive element is engaged onto said shaft and engaged with said second conductor member for selectively engaging with said central electrode of said at least one battery.

3. The socket device as claimed in claim 2, wherein said shaft includes a depression formed in an outer peripheral portion thereof, said conductive element is a conductor barrel engaged in said depression of said shaft.

4. The socket device as claimed in claim 2, wherein said shaft includes at least one peripheral shoulder formed therein for engaging with said conductor barrel and for anchoring said conductor barrel to said shaft.

5. The socket device as claimed in claim 2, wherein said conductive element includes a slot formed therein, said shaft includes a protrusion extended therefrom and engaged through said slot of said conductive element.

6. The socket device as claimed in claim 2, wherein said shaft includes a knob for rotating said shaft relative to said housing.

7. The socket device as claimed in claim 2, wherein said housing includes a receptacle engaged therein for receiving said circuit board therein.

8. The socket device as claimed in claim 7, wherein said housing includes a spring member engaged with said receptacle for biasing said first conductor member to engage with said coupler and for biasing said second conductor member to engage with said conductive element.

9. The socket device as claimed in claim 1, wherein said housing includes a casing engaged onto said light member and engaged in said passage of said driving shank.

10. The socket device as claimed in claim 1, wherein said housing includes a spring-biased projection engaged therein for engaging with said coupling member of said coupler and for retaining said coupling member of said coupler to said housing.

11. The socket device as claimed in claim 1, wherein said coupler includes a compartment formed in said coupling member for receiving said at least one battery.

12. The socket device as claimed in claim 11, wherein said coupler includes a container engaged into said compartment of said coupler for receiving said at least one battery.

13. The socket device as claimed in claim 11, wherein said coupler includes a spring member engaged with said at least one battery for biasing said central electrode of said at least one battery to selectively engage with said conductive element.
